(19) United States
(12) Patent Application Publication
(10) Pub. No.: US 2026/0141673 A1
(43) Pub. Date: May 21, 2026

(54) Method for recognizing patterns in image data

(71) Applicant: ROBERT BOSCH GmbH, Stuttgart (DE)

(72) Inventors: Simon Hackenbroich, Ostfildern (DE); Johannes Peter Berger, Leonberg (DE); Fabian Meyer, Rottweil (DE); Benjamin Resch, Tubingen (DE); Melanie Nemec, Berlin (DE); Johann Hamm, Wolfsburg (DE)

(21) Appl. No.: 18/950,656

(22) Filed: Nov. 18, 2024

(51) Int. Cl. G06V 10/44; G06T 7/80; G06V 20/56

(52) U.S. Cl. CPC G06V 10/44; G06T 7/80; G06V 20/56; G06T 2207/30204; G06T 2207/30252

(57) ABSTRACT

The invention relates to a method (100) for recognizing patterns (210) in image data (310), comprising the following steps:
providing (101) the image data (310),
determining (102) gradient information (410) on the basis of the image data (310) provided, wherein the gradient information (410) correlates with at least one image gradient in the image data (310) provided,
determining (103) edge information (420) on the basis of the image data (310) provided, wherein the edge information (420) represents at least one or multiple edge image points (430) in the image data (310) provided,
evaluating (104) the image data (310) provided on the basis of the gradient information (410) and the edge information (420),
providing (105) at least one or multiple pattern representations (450) for the recognition of the pattern (210) on the basis of the evaluation (104).

The invention relates to a method for recognizing patterns in image data. The invention further relates to a computer program, a device, and a storage medium for this purpose.

### PRIOR ART

In many image processing applications, it is necessary to identify specific objects or markings in the images. Many of these objects contain unique and repeating region with a high level of contrast, such as pedestrian crossings, barcodes, or markings for calibration or cartography tasks. The reliable recognition of such patterns can, however, present a challenge.

One common approach to detecting such patterns, such as barcodes or circles, is to perform a Hough transform. These methods are described in various publications, such as the following:
R. O. Duda and P. E. Hart, “Use of the Hough Transformation to Detect Lines and Curves in Pictures,” Commun. ACM, vol. 15, no. 1, pp. 11-15, 1972.
A. Zamberletti, I. Gallo and S. Albertini, “Robust Angle Invariant 1D Barcode Detection,” in 2nd IAPR Asian Conference on Pattern Recognition (ACPR), Naha, Japan, 2013.

The approach when using the Hough transform is often sufficient when the region of interest is largely reduced to the target, even given few or no similar objects.

A further conventional approach is the detection of CCTag markings (see L. Calvet, P. Gurdjos, C. Griwodz and S. Gasparini, “Detection and Accurate Localization of Circular Fiducials under Highly Challenging Conditions,” in IEEE Conference on Computer Vision and Pattern Recognition (CVPR), Las Vegas, United States, 2016), whereby the image gradients between edge pixels are tracked in order to connect the pixels to one another and thus recognize the pattern.

### DESCRIPTION OF THE INVENTION

The object of the invention is a method having the features of claim 1, a computer program having the features of claim 8, a device having the features of claim 9, as well as a computer-readable storage medium having the features of claim 10. Further features and details of the invention follow from the dependent claims, the description, and the drawings. In this context, features and details which are described in connection with the method according to the invention are clearly also applicable in connection with the computer program according to the invention, the device according to the invention, as well as the computer-readable storage medium according to the invention, and respectively vice versa, so mutual reference is always made or may be made with respect to the individual aspects of the invention. The object of the invention is in particular a method for recognizing patterns in image data. The method may comprise the following steps, which are preferably performed sequentially and/or repeatedly.

Initially, the image data can be provided in the method according to the invention. For this purpose, the image data may have, e.g., been previously recorded by a sensor such as a camera sensor. In other words, the image data can result from a recording by a sensor and be provided-in particular digitally-for processing as part of the method according to the invention. The image data comprise, e.g., at least one digital image or precisely one digital image.

According to a further method step, gradient information can then be determined on the basis of the image data provided. The gradient information can in this case correlate with at least one image gradient in the image data provided. The term “image gradient” is in particular understood to mean a vector field that indicates the direction and magnitude of the change in intensity of the (digital) image represented by the image data in each image point. Preferably, the gradient information thus comprises at least directional information which can be specific to a line pattern in the image data.

According to a further method step, a determination of edge information can be provided on the basis of the image data provided, and in particular on the basis of the gradient information determined. The edge information can in this case represent at least one or multiple edge image points in the image data provided. The edge image points are, e.g., edge pixels and can be understood as those image points or pixels in a digital image situated at the transitions between different lines, objects, or backgrounds. These edge image points are usually characterized by a large change in brightness, color, or intensity. The edge information can, e.g., directly indicate the edge image points, or also be designed as an edge map, i.e. a binary mask in particular.

According to a further method step, an evaluation of the image data provided can take place on the basis of the gradient information and the edge information. The evaluation can, e.g., be the repeated drawing of line segments in order to obtain at least one or multiple polylines. On this basis, at least one or multiple pattern representations can be provided for recognizing the pattern. The pattern representation can, e.g. comprise a representation, in digital form, of the polylines obtained. Accordingly, the method can also be referred to as a polyline detector.

This proposed polyline detector is able to reliably identify a pattern as a target object, even in difficult situations, because the contextual structure of the target object can be incorporated in order to distinguish the latter from similar-looking objects in the image data.

The invention can, e.g., be used for the image-based recognition of patterns with a high level of contrast, such as black-and-white marking patterns (e.g., for calibrating cameras) or the recognition of objects having repeating, high-contrast patterns. The invention can thereby have the advantage that the known “CCTag” method as such can be extended to any desired shape and pattern, and can thus be effectively employed in a broader range of applications. For example, the patterns can also comprise a stripe pattern (with straight lines) and/or a pattern in which the lines in the foreground are white and the background is black.

This invention in particular thus expands known polyline detection solutions in order to detect any desired contrast-based patterns. For example, CCTags represent one known solution, as described in L. Calvet, P. Gurdjos, C. Griwodz, and S. Gasparini, “Detection and Accurate Localization of Circular Fiducials under Highly Challenging Conditions,” in IEEE Conference on Computer Vision and Pattern Recognition (CVPR), Las Vegas, United States, 2016. In particular, the method according to the invention can comprise a tracking of image gradients and a generation of polylines in order to work with patterns having a foreground with a high level of intensity (white) and background with a low level of intensity (black), which is to some degree the reverse of CCTags. The invention can provide a robust solution for detecting what is referred to as the “topview target” and similar derivatives thereof. In this context, topview targets are a common calibration pattern for parking assistance cameras on vehicles in production repair facilities. The invention invention advantageously enables the recognition of patterns with any desired number of (not just circular) lines and patterns with a white foreground and black background.

It can preferably be provided that the evaluation of the image data provided comprises a determination of at least one polyline on the basis of the gradient information and the edge information. The respective polyline can in this case define multiple line segments (in particular linked to one another) between the edge image points, which segments extend depending on the image gradients, in particular following the latter in order to provide the at least one pattern representation on this basis. In other words, the polyline can be defined by linking multiple line segments together between the edge image points. As a result, a significant characteristic is acquired which is meaningful for the pattern and is used the for acquiring the pattern.

It is also advantageous for the edge information to represent a plurality of the edge image points in the image data provided. The evaluation of the image data provided can further comprise a determination of at least one polyline on the basis of the gradient information and the edge information. The polylines can each comprise line segments which are between a plurality of the edge image points and extend depending on, and preferably following, the image gradient. The respective pattern representation can be represented by a plurality of the polylines thus determined. As a result, the pattern can in particular be reliably recognized by an accumulation of a plurality of the polylines occurring in comparison to the further image content in the image data.

It is also conceivable for the edge information to represent a plurality of the edge image points in the image data provided. During the evaluation of the image data provided, the image gradient can then be (repeatedly) followed from a beginning or following point of the edge image points in the image gradients to a subsequent following or end point of the edge image points. This enables the at least one pattern representation to be provided on this basis. Preferably, line segments are drawn and/or a respective polyline is thus formed as a result. The points can change with each repetition, so that the line segments are drawn as linked segments. In addition, the positive and negative gradients can be followed in alternation during the repetitions in order to form the polyline. The evaluation can, by way of example, act as a specific algorithm and, e.g., perform the following steps: 1. calculation of the gradient information, preferably the image gradients, in the digital image; 2.calculation of the edge information, in particular edge pixels, based on the gradient information or image gradients; 3. forming polylines by, repeatedly and in a linked manner, starting from an edge pixel and following the gradient information, or rather the image gradients, to the next edge pixel. As a result, the polyline detector is much more robust against disturbances (such as similar-looking objects or patterns in an image) than conventional methods like a Hough transform, even if they are in close proximity to the actual target object.

It can also be provided that one or more of the pattern representations each comprise(s) a plurality of polylines which were determined during the evaluation, whereby the pattern is recognized based on an accumulation of the polylines. The pattern can be reliably identified by detecting accumulations of this kind in the image.

Furthermore, it is optionally possible within the scope of the invention for the pattern to be designed as a calibration pattern, whereby at least one sensor, preferably at least one camera of a vehicle, can be calibrated on the basis of the pattern recognized. The image data can in this case result from a recording by the sensor, preferably the camera. For example, a parking assistance means of the vehicle or an automated or autonomous driving function will be calibrated for this purpose.

According to a further option, it can be provided that the edge information is determined on the basis of the gradient information in order to determine the edge image points (in particular in the form of edge pixels) in the image data. In this case, the edge image points or edge pixels mark a transition between different color and/or brightness ranges in the image data. In addition, the edge information can preferably be determined by an edge tracking or edge discovery algorithm in order to represent contours or boundaries of objects and patterns depicted in the image data.

The recognition of the pattern can advantageously comprise image classification, in which the pattern to be identified is detected on the basis of the pattern representation (and thus based on the edge image points in particular). Based on the image classification, pattern deviations from a reference can, e.g., be determined, and a calibration of a sensor that was used to record the image data takes place in this manner. The image data can, e.g., be images from a camera sensor, and/or a radar sensor, and/or an ultrasonic sensor, and/or a LiDAR sensor, and/or a thermal camera.

The object of the invention is also a computer program, in particular a computer program product comprising commands that, when the computer program is executed by a computer, prompt the latter to perform the method according to the invention. The computer program according to the invention thereby provides the same advantages as described in detail with regard to a method according to the invention.

The object of the invention is also a device for data processing which is configured to perform the method according to the invention. For example, a computer can be provided as the device which executes the computer program according to the invention. The computer can comprise at least one processor for executing the computer program. A non-volatile data storage means can also be provided, in which the computer program is stored and from which the computer program can be read by the processor for execution.

The object of the invention can also be a computer-readable storage medium comprising the computer program according to the invention and/or comprising instructions that, when executed by a computer, prompt the latter to perform the method according to the invention. The storage medium is, e.g., designed as a data storage means such as a hard disk, and/or a non-volatile memory, and/or a memory card. The storage medium can, e.g., be integrated into the computer.

The method according to the invention can furthermore be designed as a computer-implemented method.

Further advantages, features, and details of the invention follow from the description hereinafter, in which embodiments of the invention are described in detail with reference to the drawings. In this context, each of the features mentioned in the claims and in the description may be essential to the invention, whether on their own or in any combination. Shown are:

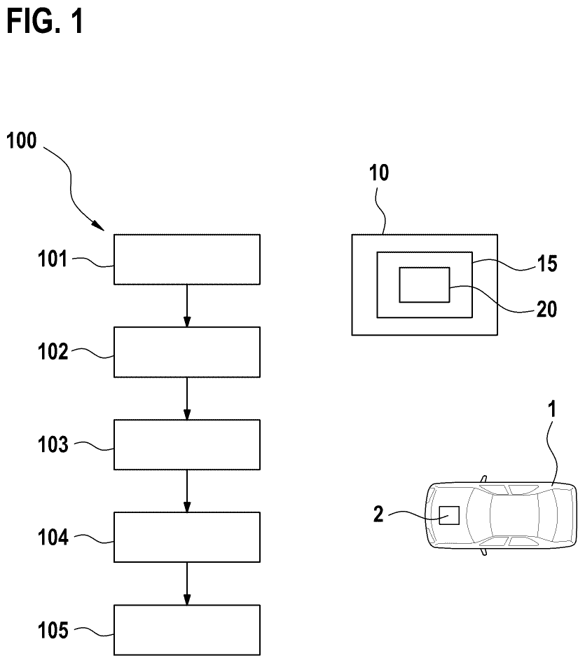

FIG. 1 a schematic illustration of a method, a device, a storage medium, as well as a computer program according to exemplary embodiments of the invention.

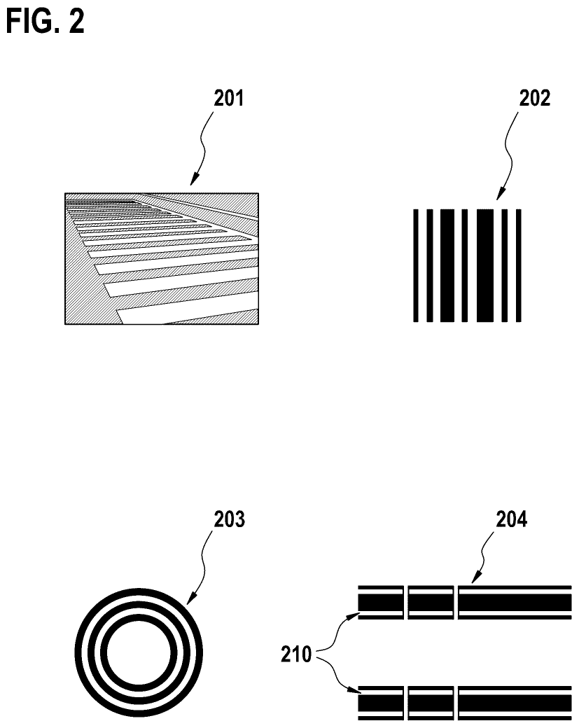

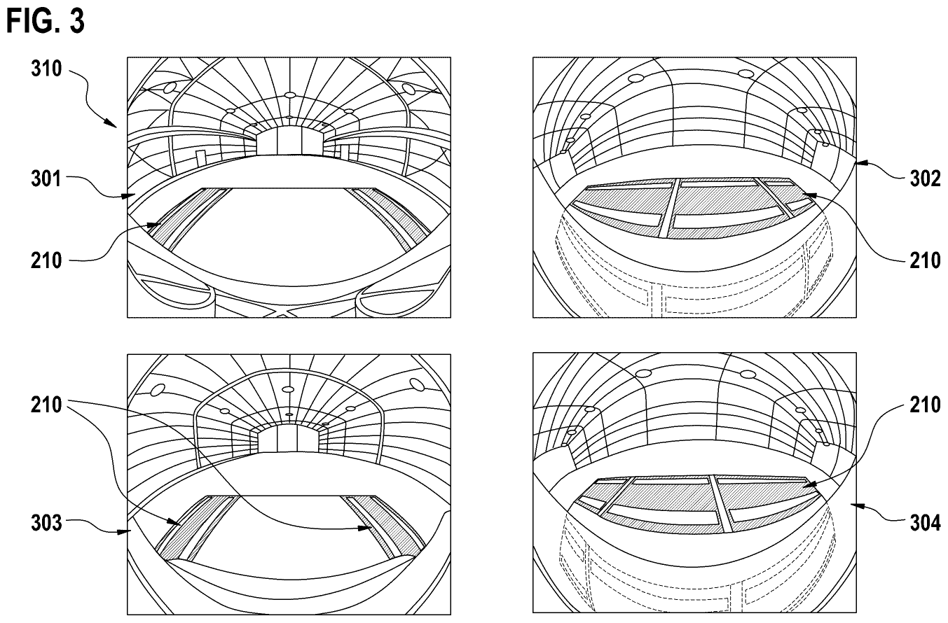

FIGS. 2-3 schematic illustrations of various patterns.

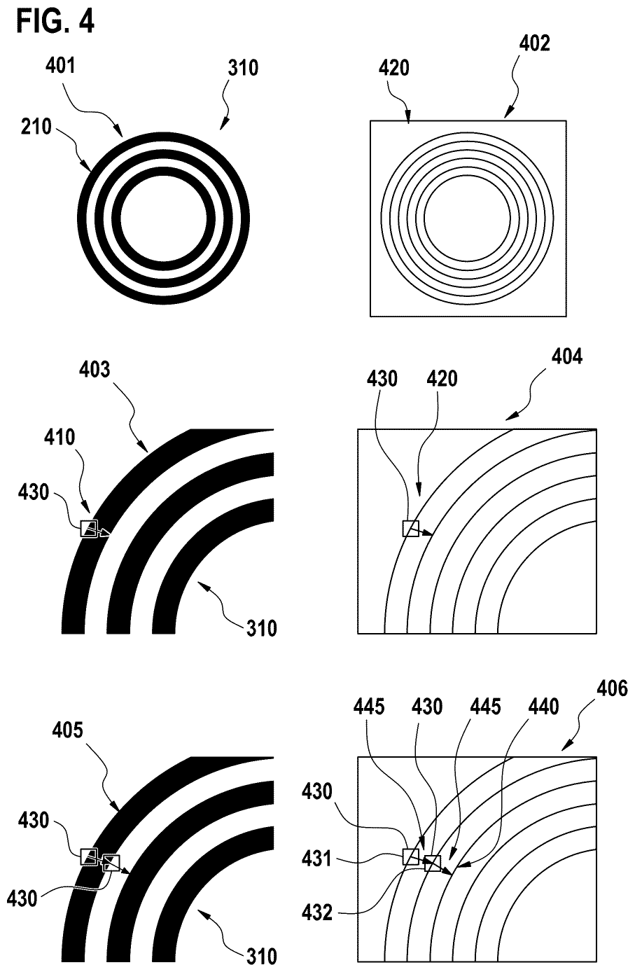

FIGS. 4-6 schematic representations of method steps in a method according to exemplary embodiments of the invention.

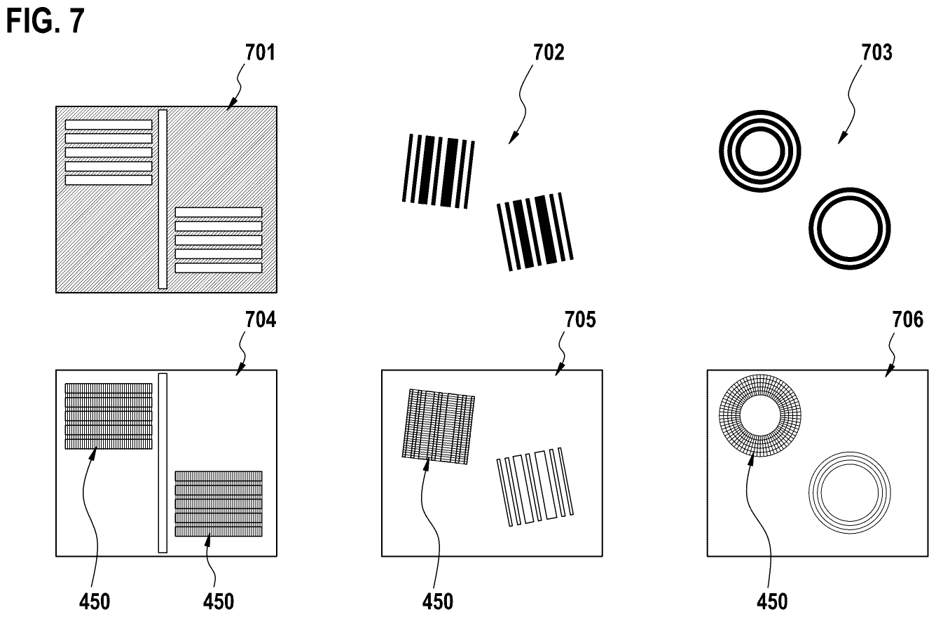

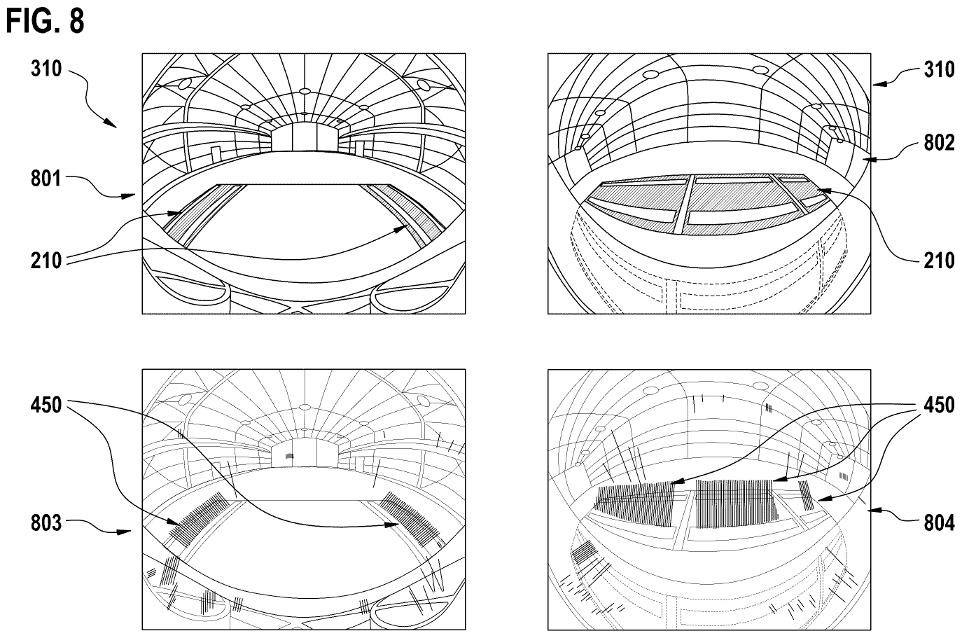

FIGS. 7-8 schematic illustrations of various pattern representations.

Schematically shown in FIG. 1 are a method 100, a device 10, a storage medium 15, as well as a computer program 20 according to exemplary embodiments of the invention. Also shown is a vehicle 1 comprising a sensor 2, which can be used to record image data.

FIG. 1 also illustrates a method 100 for recognizing patterns 210 in image data 310 according to exemplary embodiments of the invention. According to a first method step 101, the image data 310 illustrated in FIG. 3 (and elsewhere) can be provided, which data were previously recorded by the sensor 2. According to a second method step 102, a determination the gradient information 410 illustrated in FIG. 4 is then performed on the basis of the image data 310 provided. The gradient information 410 can correlate with at least one image gradient in the image data 310 provided. According to a third method step 103, a determination of the edge information 420 also shown in FIG. 4 is subsequently performed on the basis of the image data 310 provided, whereby the edge information 420 represents at least one or multiple edge image points 430 in the image data 310 provided. According to a fourth method step 104, this enables an evaluation of the image data 310 provided on the basis of the gradient information 410 and the edge information 420.

According to a fifth method step 105, one or multiple pattern representations 450 can then be provided for the recognition of the pattern 210 on the basis of the evaluation 104.

FIG. 2 shows examples of patterns 210 in images, such as a zebra stripe 201, a barcode 202, and a CCTag marker 203. Also shown is an overhead view of a calibration target 204, i.e. a type of pattern 210 which can, e.g., be used to calibrate cameras of a vehicle. These and similar targets are widespread in production and service facilities. According to embodiments of the invention, white stripes on a black background are preferably used as the pattern 210 and can be attached to the vehicle in order to calibrate the parking assistance cameras thereof. Robust polyline detection can be very beneficial in performing the calibration with greater reliability.

Whereas reliable detection of objects and markers in clean, laboratory-like, and strictly controlled environments is already a challenging task, the scenes in real-world scenarios may, however, be saturated with unknown-and possibly similarly structured-objects in close proximity to the target object. Such scenarios require a highly robust detection method that reliably identifies the target object and avoids erroneous detection and interference from other objects.

FIG. 3 shows examples of image data 310 shots from a front camera 301, a left-side camera 302, a rear camera 303, and a right-side camera 304, each capturing a top-view target as the pattern 210. In a camera calibration scenario using the top-view target, the target is, e.g., placed around a vehicle such that each camera can see portions of the target. The calibration algorithm recognizes the target in a single shot and uses known 3D measurements of the target to determine the extrinsic camera parameters. In this context, it should be noted that, given realistic calibration scenes in production or service facilities outside of a cleanroom laboratory, the image content of the image is usually saturated with unknown, interfering objects.

FIG. 4 illustrates the ability for the evaluation 104 of the image data 310 provided to comprise a determination of at least one polyline 440 on the basis of the gradient information 410 and the edge information 420. The respective polyline 440 can in this case define multiple line segments 445 between the edge image points 430, which segments extend depending on the image gradients in order to provide the at least one pattern representation 450 on this basis. Specifically, during the evaluation 104 of the image data 310 provided it is possible to repeatedly follow the image gradient, starting from a beginning or following point 431 of the edge image points 430 to a subsequent following or end point 432 of the edge image points 430 in order to provide the at least one pattern representation 450 on this basis, and preferably to draw line segments 445 and form a respective polyline thereby.

FIG. 4 shows multiple illustrations for clarifying the method according to exemplary embodiments of the invention. For example, given an input image 401, 403, 405, the detector can, based on the image data, initially calculate the gradient of each pixel in these input images and then create an edge image 402, 404, 406 by means of, e.g., a Sobel filter and a Canny edge detector. In particular, the Sobel filter includes a gradient calculation method based on the application of two filters, which are oriented horizontally and vertically. The Canny edge detector is, e.g., an algorithm in which threshold analysis and hysteresis are applied in order to reduce noise and erroneous detections and determine a binary edge image based on the gradient information. Depiction 401 shows one example of a CCTag-like circular marker, based on which an edge image 402 is calculated. Depictions 403 to 406 are the corresponding, enlarged illustrations.

Based on the edge image 402, 404 and 406, the method according to exemplary embodiments of the invention can form polylines using the following algorithm: Any given edge pixel e0 is selected as the starting point 431, after which the negative gradient is initially followed along a straight line (see the rectangle in depiction 403 for clarification). If the algorithm encounters an edge pixel within a certain maximum distance, then this new pixel will be used as the next point e1, meaning that a following or end point 432 is selected in the polyline sequence (see depiction 404). Starting from e1, the positive gradient is again then followed in a straight line (see the rectangle in depictions 403 to 406 for clarification). This alternating line tracking scheme can be repeated until either the desired number of points (nodes) for each polyline is reached (whereby one polyline should have exactly six nodes) or the line tracking was unable to find another edge pixel in the gradient direction.

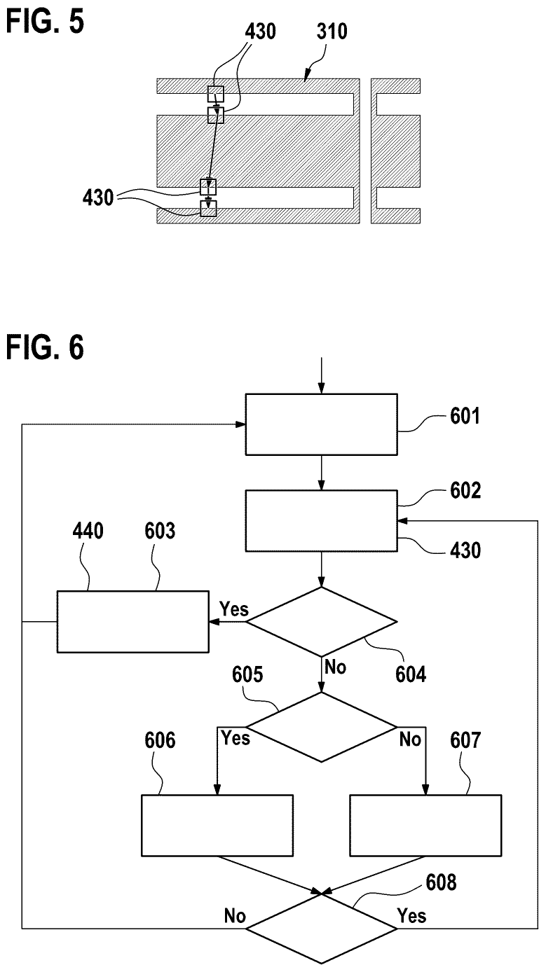

However, the example shown in FIG. 4, in which a CCTag marker is used, is a low-intensity pattern (black) on a high-intensity background (white). If the pattern has a high level of intensity and is printed on a low-intensity background, e.g. for the calibration target as seen from above, then reliability can be improved by means of the method according to embodiments of the invention. For example, polylines can be formed by initially following the image gradient in the positive direction, then in the negative direction, and so on (see FIG. 5 for clarification). This algorithm can be repeated for each edge pixel in the image. Given that the exact number of nodes for each polyline and the pattern may be known a priori, the detector will only generate valid polylines which originate from edge pixels (in this case either from the upper or lower contour).

The flow chart shown in FIG. 6 illustrates the process according to embodiments of the invention, along with further details. According to a first step 601, a first edge pixel is initially selected as the starting point (see 602). According to step 604, it is verified whether the polyline 603 is complete. If the polyline is not yet complete, it can be verified according to step 605 whether the number of nodes detected thus far is even or odd. If the number is even, then a further edge pixel can be searched for along a negative gradient (see 606). Otherwise, the search is along a positive gradient (see 607). If another edge pixel was found in 608, then this can be registered in step 602 and the completeness of the polyline verified again in 604. Regions or contours with a significant number of correctly recognized polylines will then represent the desired target with a high level of probability.

FIG. 7 illustrates examples of targets, along with similar-looking objects. Depiction 701 shows two zebra stripes with a separating line. Depiction 702 shows a barcode next to an artifact that is similar to a barcode. Shown in depiction 703 is a CCTag next to a similar pattern. Depictions 704 to 706 show the associated edge images and polylines, which can be recognized by means of a method according to embodiments of the invention. It is clear that the polylines are determined only, or primarily, for the desired targets and not for the similar objects. The examples illustrate how the polyline detector desible able to distinguish the actual target object from similar-looking nearby objects.

FIG. 8 shows the successful application of polyline recognition 803, 804 to camera images 801 and 802. The calibration target, as seen from above, can be reliably identified in confusing scenes, even in the case of reflections on a vehicle chassis. The foregoing explanation of the embodiments describes the present invention only by way of examples. Insofar as technically practical, specific features of the embodiments may obviously be combined at will with one another without departing from the scope of the present invention.

1. A method for recognizing patterns in image data, comprising the following steps:
providing the image data,
determining gradient information on the basis of the image data provided, wherein the gradient information correlates with at least one image gradient in the image data provided,
determining edge information on the basis of the image data provided, wherein the edge information represents at least one or multiple edge image points in the image data provided,
evaluating the image data provided on the basis of the gradient information and the edge information, and
providing at least one or multiple pattern representations for the recognition of the pattern on the basis of the evaluation.

2. The method according to claim 1, characterized in that
the evaluation the image data provided comprises a determination of at least one polyline on the basis of the gradient information and the edge information, wherein the respective polyline defines multiple line segments which are between the edge image points and extend depending on the image gradient in order to provide the at least one pattern representation on this basis.

3. The method according to one of the claim 1, characterized in that
the edge information represents a plurality of edge image points in the image data provided, wherein the evaluation of the image data provided comprises a determination of a plurality of polylines on the basis of the gradient information and the edge information, wherein the polylines each comprise line segments which are between a plurality of the edge image points and extend depending on the image gradient, wherein the respective pattern representation is represented by a plurality of the polylines thus determined.

4. The method according to claim 1,
characterized in that
the edge information represents a plurality of edge image points in the image data provided, wherein the evaluation of the image data provided repeatedly starts with one beginning or following point of the edge image points and follows the image gradients to a subsequently following or end point of the edge image points in order to provide the at least one pattern representation on this basis.

5. The method according to claim 1,
characterized in that
one or more of the pattern representations each comprises a plurality of the polylines which were determined during the evaluation, wherein the pattern (210) is recognized based on an accumulation of the polylines.

6. The method according to claim 1, characterized in that the pattern is designed as a calibration pattern, wherein, based on the pattern recognized, at least one sensor, is calibrated, wherein the image data result from a recording by the sensor.

7. The method according to claim 1, characterized in that the edge information is determined on the basis of the gradient information in order to determine the edge image points in the form of edge pixels in the image data, wherein the edge pixels mark a transition between different color or brightness regions in the image data.

8. (canceled)

9. A device for data processing, the device comprising:
a processor; and
a memory storing commands that, when executed by the processor, cause the processor to:
provide the image data,
determine gradient information on the basis of the image data provided, wherein the gradient information correlates with at least one image gradient in the image data provided.
determine edge information on the basis of the image data provided, wherein the edge information represents at least one or multiple edge image points in the image data provided,
evaluate the image data provided on the basis of the gradient information and the edge information, and
provide at least one or multiple pattern representations for the recognition of the pattern on the basis of the evaluation.

10. A tangible non-transitory computer-readable storage medium comprising commands that, when executed by a computer, prompt the computer to:
provide the image data,
determine gradient information on the basis of the image data provided, wherein the gradient information correlates with at least one image gradient in the image data provided,
determine edge information on the basis of the image data provided, wherein the edge information represents at least one or multiple edge image points in the image data provided,
evaluate the image data provided on the basis of the gradient information and the edge information, and
provide at least one or multiple pattern representations for the recognition of the pattern on the basis of the evaluation.

11. The method according to claim 4, wherein the following of the image gradients to the subsequently following or end point of the edge image points is further in order to draw line segments and form a respective polyline thereby.

12. The method according to claim 6, wherein the sensor is a camera of a vehicle.

13. The method according to claim 7, wherein the edge information is determined by an edge tracking or edge discovery algorithm in order to display contours or boundaries of objects and patterns depicted in the image data.
